(19) United States
(12) Patent Application Publication
(10) Pub. No.: US 2004/0093402 A1
(43) Pub. Date: May 13, 2004

(54) System and method for managing a computer system performance tuning initiative in a networked computing environment

(76) Inventors: James Liu, Sunnyvale, CA (US); Youn-Seo Roh, Sunnyvale, CA (US); John Gustafson, Cupertino, CA (US)

Correspondence Address: PARK, VAUGHAN & FLEMING LLP, 508 SECOND STREET, SUITE 201, DAVIS, CA, 95616, US

(21) Appl. No.: 10/292,850

(22) Filed: Nov. 12, 2002

(51) Int. Cl. G06F 15/173

(52) U.S. Cl. 709/223

(57) ABSTRACT

One embodiment of the present invention provides a system and method for managing a computer system performance tuning initiative in a networked computing environment. A submission package including a plurality of individual fields identifying a software application candidate for performance tuning is received. Each field describes a quantifiable aspect of the candidate software application. Each field in the submission package is parsed into normalized content and the parsed content is evaluated for completeness and correctness. Approval of each evaluated submission package for performance tuning is solicited by presenting a percentage reflecting overall completeness and correctness. Tuner sign-up and status and tracking performance tuning progress are monitored following approval of each evaluated submission package. Results from the performance tuning are apprised upon completion.

### BACKGROUND

1. Field of the Invention

The present invention relates in general to computer system performance tuning management, and, in particular, to a system and method for managing a computer system performance tuning initiative in a networked computing environment.

2. Related Art

Historically, the computer industry has been stratified into individual sectors reflecting the high degree of specialization in the field. These sectors include server, desktop, microprocessor, operating system, network infrastructure, security, and enterprise solutions, just to name a few. Generally, end-user software is authored by third party vendors while operating systems are provided by either the hardware vendor that manufactures the system or by a third party software publisher or consortium that has written operating system software for specific, compatible hardware environments. The operating system is the most critical component, linking the hardware with the end-user software to enable the combination to produce a useful result.

To accommodate as many forms of third-party software applications as possible, operating systems are designed to provide an acceptable level of performance as a generic operating platform. Every environment is unique in terms of the types and versions of software installed, both at the operating system and application levels. Operating system and environment variables can significantly affect performance. Thus, most third-party software applications can benefit from improved performance tuning, which modifies the parameters of the underlying operating system to better meet the specific software application needs.

Hardware vendors that also develop their own operating system software are often best suited to perform performance tuning for third party software. Often, a hardware vendor will form alliances with key third party software developers for strategically-critical products, often in the enterprise computing arena. Similarly, some third party software vendors maintain informal alliances with hardware vendors to ensure compatibility and efficient program operation. The alliances enable end-users to receive support for problems or needs that may arise, particularly in cases where the source of a problem is unclear and may involve both hardware and software. Unfortunately, support does not always include tuning computing solutions for optimal performance.

Performance tuning requires adjusting the system and environment parameters used by an operating system. The four main categories of performance tuning parameters are disk, physical memory, network, and concurrency. Disk parameters affect the input and output of data to and from secondary storage. Physical memory parameters affect memory allocation, de-allocation, and efficient page and cache operation. Network parameters affect data throughput with external systems over network connections. Concurrency parameters, in particular, thread concurrency, affect efficient context switches and synchronization between parallel and coordinating processes.

One solution to providing increased performance is to install faster computer hardware in lieu of tuning. The price of hardware has significantly declined over the last fifteen years and significant gains in performance can be achieved simply by upgrading the underlying hardware platform. However, upgrading hardware can be expensive and time consuming, particularly when an end-user has a large base of installed systems. Moreover, from a software vendor point of view, requiring hardware upgrades to run third party application software is a disincentive to would-be software purchasers.

Performance tuning offers an attractive alternative to hardware upgrading by presenting a ready solution to achieving enhanced application performance at significantly lower cost. Ideally, performance tuning can best be performed by the software engineers responsible for directly supporting an operating system. These individuals are most familiar with the advantages, as well as shortcomings, of an operating system installed on a specific hardware platform and can directly affect changes into the operating system itself, if necessary.

Internally, an operating system developer can promote performance tuning by software engineers as an extra-curricular activity through monetary incentive awards. The potential range of system configurations can be large and varied and can significantly tax the resources available to a vendor for providing end-user operating system support. Encouraging performance tuning as an extra-curricular activity allows a software vendor to address the need to provide application performance tuning without having to dedicate significant corporate fiscal resources to the effort. As well, incentives can be tiered to draw focus to tuning in specific areas of third party application software in need of attention.

Administering a performance tuning initiative can pose management challenges to a software vendor, particularly when the tuning activities are expected to be performed extra curricularly, possibly off-site, during non-working hours. The problem becomes increasingly complex as the sophistication of meeting deadlines and milestones or earning of an incentive is measured in an automated fashion. Further, administering a performance tuning initiative remotely, such as via an internetwork, such as the Internet, requires carefully structuring a support framework.

Therefore, there is a need for an approach to managing a plurality of application performance tuning efforts remotely distributed between initiative participants, including submitters, tuners, and approvers.

There is a further need for an approach to quantifying submissions and results in terms of measurable application performance gains and losses.

There is further need for an approach to monitoring the progress of incentivized conduct of tuners and to protect against abuses.

### SUMMARY

One embodiment of the present invention provides a system and method for managing a computer system performance tuning initiative in a networked computing environment. A submission package including a plurality of individual fields identifying a software application candidate for performance tuning is received. Each field describes a quantifiable aspect of the candidate software application. Each field in the submission package is parsed into normalized content and the parsed content is evaluated for completeness and correctness. Approval of each evaluated submission package for performance tuning is solicited by presenting a percentage reflecting overall completeness and correctness. Tuner sign-up and status and tracking performance tuning progress are monitored following approval of each evaluated submission package. Results from the performance tuning are apprised upon completion

In a variation on this embodiment, the parsed content is quantified.

In a variation on this embodiment, a deadline tied to at least one of the group comprising package submission, tuner sign-up, and tuning completion is set, and whether the deadline has occurred attendant to the at least one of package submission, tuner sign-up, and tuning completion is determined.

In a variation on this embodiment, interim performance tuning results are evaluated.

In a variation on this embodiment, a logical framework to remotely manage the performance tuning initiative is generated.

In a variation on this embodiment, a graphical user interface with interactive user controls within the logical framework is provided.

In a variation on this embodiment, the tuner status is periodically updated.

In a variation on this embodiment, the parsed content consists of at least one individual field comprises a Uniform Resource Locator (URL), and a look-up of the referenced URL is executed.

In a variation on this embodiment, a color-coded notification is generated upon at least one event selected from the group comprising a close deadline and a recently-modified submission package.

### BRIEF DESCRIPTION OF THE FIGURES

FIG. 1 is a block diagram showing a system for managing a computer system performance tuning initiative in a networked computing environment in accordance with an embodiment of the present invention.

FIG. 2 is a block diagram showing the software modules implementing the performance tuning initiative system of FIG. 1.

FIG. 3 is a functional block diagram showing a process flow following a performance tuning initiative, as performed on the system of FIG. 1.

FIG. 4 is a flow diagram showing a method for managing a computer system performance tuning initiative in a networked computing environment in accordance with an embodiment of the present invention.

FIG. 5 is a flow diagram showing the routine for reviewing a submission package for use in the method of FIG. 4.

FIG. 6 is a screenshot showing, by way of example, the application submission dashboard generated by the tuning server of FIG. 1.

FIG. 7 is a flow diagram showing a routine for checking content for use in the routine of FIG. 5.

FIG. 8 is a flow diagram showing the routine for approving a submission for use in the method of FIG. 5.

FIG. 9 is a screenshot showing, by way of example, a tuning dashboard generated by the tuning server 11 of FIG. 1.

FIG. 10 is a flow diagram showing the routine for approving a bonus for use in the method of FIG. 5.

FIG. 11 is a screenshot showing, by way of example, an application summary generated by the tuning server of FIG. 1.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. This includes, but is not limited to, magnetic and optical storage devices such as disk drives, magnetic tape, CDs (compact discs) and DVDs (digital versatile discs or digital video discs), and computer instruction signals embodied in a transmission medium (with or without a carrier wave upon which the signals are modulated). For example, the transmission medium may include a communications network, such as the Internet.

System For Managing A Computer System Performance Tuning Initiative

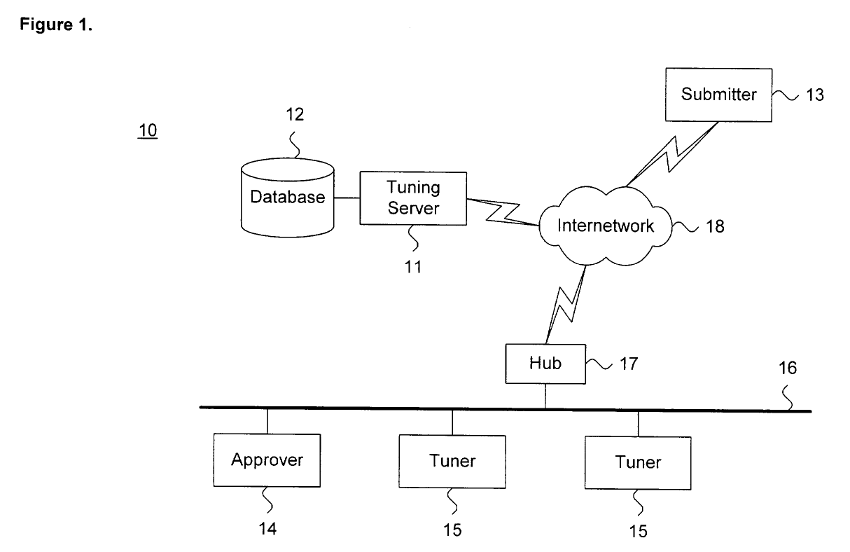

FIG. 1 is a block diagram showing a system for managing a computer system performance tuning initiative 10 in a networked computing environment in accordance with an embodiment of the present invention. Individual computer systems, including a tuning server 11, a submitter client 13, an approver client 14, and tuner clients 15 communicate via an internetwork 18, such as the Internet, or any other form of wide-area or local-area network or combinations thereof. By way of example, the approver client 14 and tuner clients 15 communicate locally via an intranetwork 16, and the intranetwork 16, in turn, is interfaced to the internetwork 18 via a hub 17.

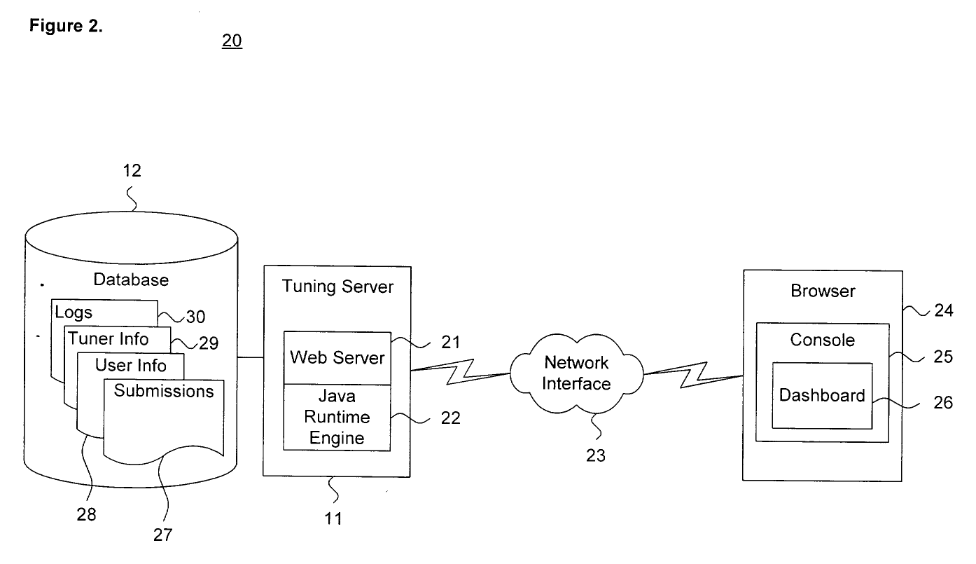

The tuning server 11 enables a computer system performance tuning initiative to be remotely managed and administered by client systems, primarily the approver client 14, as further described below with reference to FIG. 2. The tuning server 11 includes an attached storage device holding a database 12 for persistently storing performance tuning initiative information. Other arrangements and combinations of computer systems and network components arranged in various topologies and configurations are possible, as would be recognized by one skilled in the art.

Software Modules

FIG. 2 is a block diagram showing the software modules 20 implementing the performance tuning initiative system 10 of FIG. 1. The performance tuning initiative system 10 consists of two groups of components. The first group consists of the tuning server 111 and database 12. The second group consists of a Web browser (Web browser) 24 executing on one or more of the client systems, including the submitter client 13, approver client 14, and tuner clients 15 (shown in FIG. 1). The tuning server 11 and Web browser 24 communicate via a network interface 23 over the internetwork 18, intranetwork 16, and other forms of computer interconnectivity, as is known in the art.

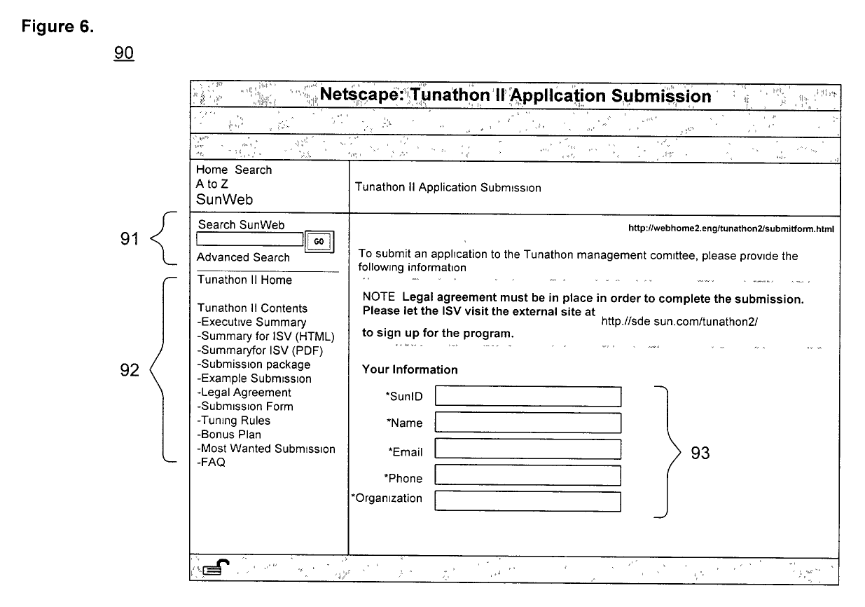

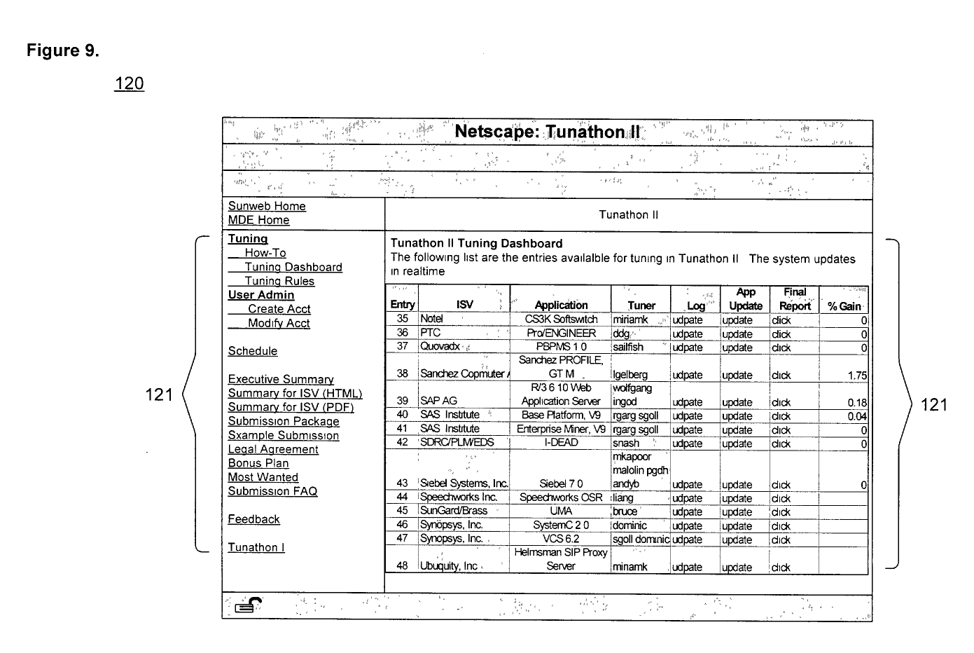

The tuning server includes two software components: Web server 21 and Java run time engine 22. The Web server 21 serves Web content (not shown) stored on an attached storage device for transmission to a requesting Web browser 24. The served Web content is interpreted by the Web browser 24 to generate a control console 25, which forms a logical framework for remotely managing a performance tuning initiative. A dashboard 26 with graphical user interface (GUI) controls is displayed within the control console 25, as further described below with reference to FIGS. 6 and 9. The Web content can be written in a tag-delimited page description language, such as HTML, or can be in an unstructured format that includes parseable text. In the described embodiment, the Java run time engine 22 is a Java 2 platform, Enterprise Edition, server-side module that executes servelets and Java Server Pages (JSPs) to generate the console 25 and dashboard 26. Other forms of providing active server content to the Web browser 24 are feasible, as is known in the art.

The database 12 stores performance tuning initiative information of four main types: submissions 27, user information 28, tuner information 29, and logs 30. The types of stored information will now be described in detail.

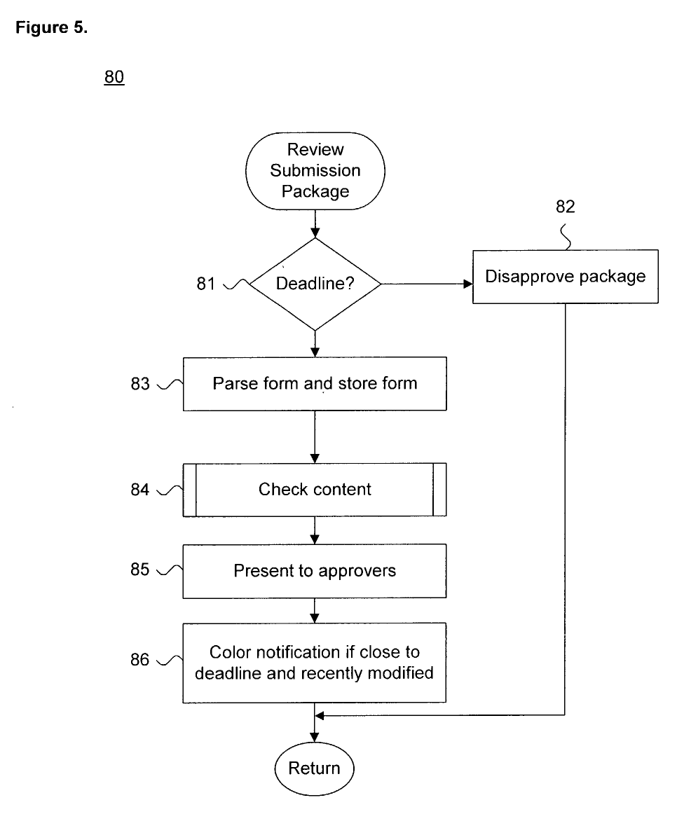

Submissions 27 are received from submitter clients 13 (shown in FIG. 1) and consist of 11 main fields of data. Each field is parsed into normalized content and is checked for completeness, as further described below with reference to FIG. 5. Each field is afforded equal weight when determining the overall completeness of the submission package. Each submission 27 includes the following fields:

(1) Source Code: Name of family tree segment, identified by version and revision number, for the application software to be performance tuned.

(2) Build Procedure: Identifies the process used to generate the application software being tuned.

(3) Known Restrictions. Identifies the executable size, build-time, error tolerance and other factors relevant to the application software being tuned.

(4) Test Cases. Lists at least three test cases as operational benchmarks by which performance tuning gains or loses will be measured.

(5) Correctness Criteria. Sets forth independent software vendor guidelines (ISV) for error tolerance and other critical factors.

(6) Target Hardware. Identifies a shipping product with memory and storage requirements.

(7) Definition of Performance. Presents quantified and measurable performance metrics.

(8) Performance Baseline. Defines the starting point against which performance tuning gains or losses will be measured.

(9) Comments: Describes code, source language, application size, and other pertinent information.

(10) Signed Contract. Completed as a process external to ensure ISV support of the performance tuning initiative efforts.

(11) Source of Hardware. Identifies the specific platform used to perform actual performance tuning.

The user information 28 and tuner information 29 identify the name, affiliation, permissions, and so forth of the user and tuner, respectively. Finally, the logs 30 record tuning results as quantified and submitted by tuners throughout the performance tuning process.

Process Flow

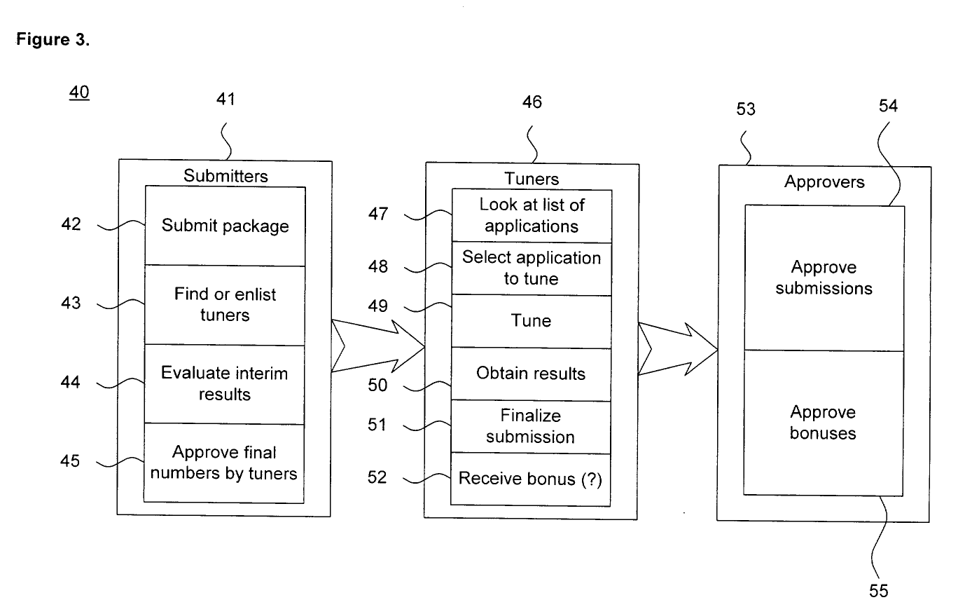

FIG. 3 is a functional block diagram showing a process flow 40 for a performance tuning initiative, as managed by the system of FIG. 1. Three groups of individuals, submitters 41, tuners 46, and approvers 53, participate in each performance tuning initiative. Submitters 41, through a submitter client 13 (shown in FIG. 1), perform four basic functions. First, submitters submit packages describing third party application software for candidate performance tuning (block 42). Submitters 41 are also responsible for finding or enlisting tuners 46 to actually carry out a performance tuning initiative on approved packages (block 43). Submitters 41 evaluate interim results provided by tuners 46 (block 44) and approve the final performance tuning numbers, as provided by the tuners 46 (block 45).

The tuners 46, through a tuner client 15 (shown in FIG. 1), perform six basic functions. First, tuners 46 look at a list of candidate application software for tuning (block 47) and can select an application to tune (block 48), preferably as an extra-curricular activity. Tuners 46 perform performance tuning (block 49), subject to predefined deadlines and obtaining performance tuning results (block 50). Working with submitters 41, tuners 46 finalize a submission (block 51) and, hopefully, receive a bonus (block 52) for successful and timely performance tuning efforts.

Finally, approvers 53, through an approver client 14 (shown in FIG. 1), perform two basic functions. First, approvers 53 approve submissions (block 54), as provided in packages by submitters 41. Approvers 53 also approve incentive bonuses (block 55).

In the described embodiment, incentives are awarded in four levels. Gold incentive awards are used to encourage performance tuning of top revenue producing third-party application software, typically earning in excess of $100 million in annual sales. Blue incentive awards are used for second-tier application software, typically in the $15-$100 million annual revenue range. White incentive awards are used for small, but strategically important, application software, with a strong potential for revenue growth. Finally, Unlisted application software is ineligible to receive incentive awards.

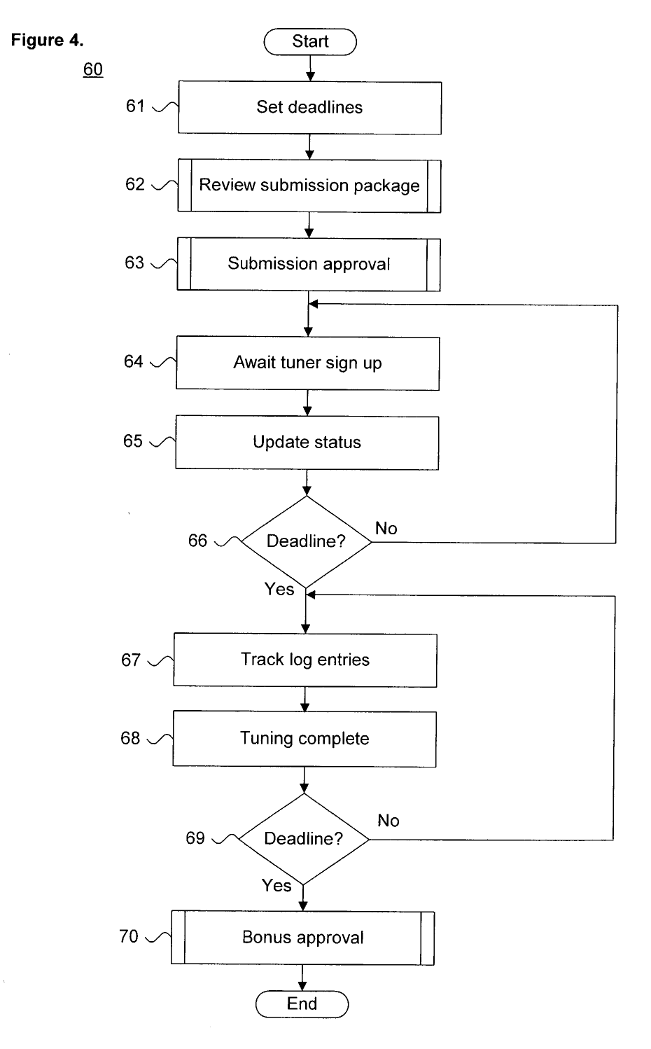

Method For Managing A Computer System Performance Tuning Initiative FIG. 4 is a flow diagram showing a method for managing a computer system performance tuning initiative 80 in a networked computing environment in accordance with an embodiment of the present invention. The method 80 is executed by the tuning server 11 (shown in FIG. 1) as a sequence of processes steps responsive to inputs received via a dashboard 26 generated on a console 25 of a Web browser 24 executed by a submitter client 13.

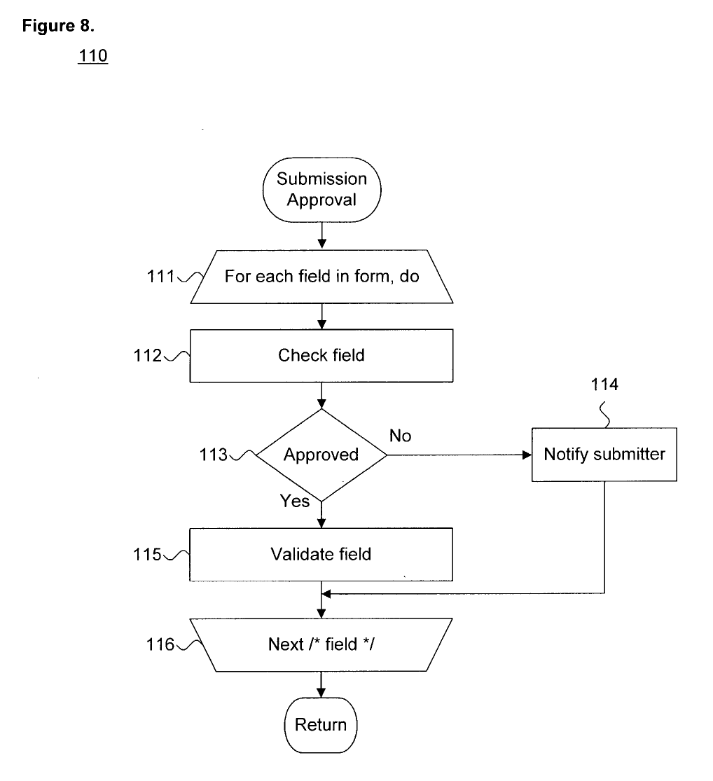

Initially, deadlines are set (block 61) for various milestones that occur throughout a performance tuning initiative. In the described embodiment, the deadlines include package submission, tuner sign-up, and tuning completion, although other deadlines are feasible, as would be recognized by one skilled in the art. Each submission package is reviewed (block 62) for correctness and completeness, as further described below with reference to FIG. 5. Following review, individual submissions are approved (block 63), as further described below with reference to FIG. 8.

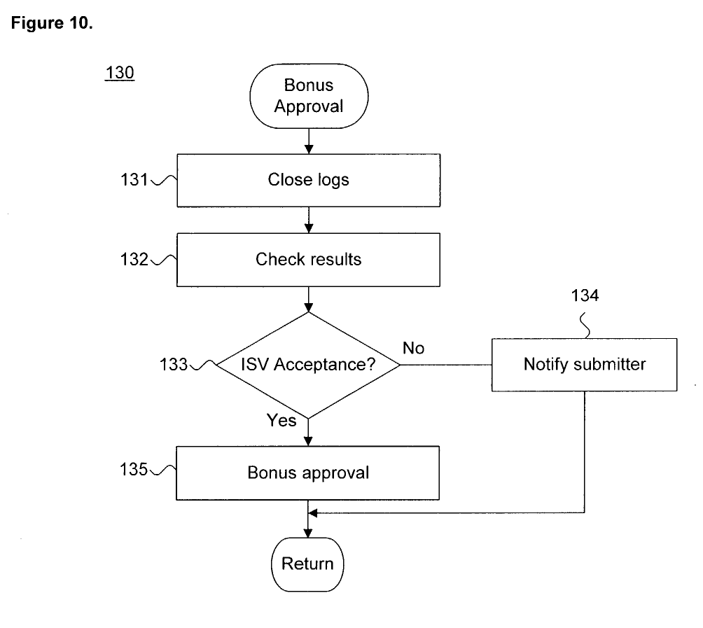

Following approval, the submission is posted to await tuner sign-up (block 64). The status of tuner sign-up is periodically updated (block 65) up through the sign-up deadline (block 66). Thereafter, log entries posted by tuner clients 15 (shown in FIG. 1) are tracked (block 67) until tuning is complete (block 68). If the tuning deadline has arrived (block 69), bonuses are approved (block 70), as further described below with reference to FIG. 10. The routine then returns.

Submission Package Review

FIG. 5 is a flow diagram showing the routine for reviewing a submission package 80 for use in the method of FIG. 4. The purpose of this routine is to quantify submissions and ensure completeness and correctness prior to tuner sign-up.

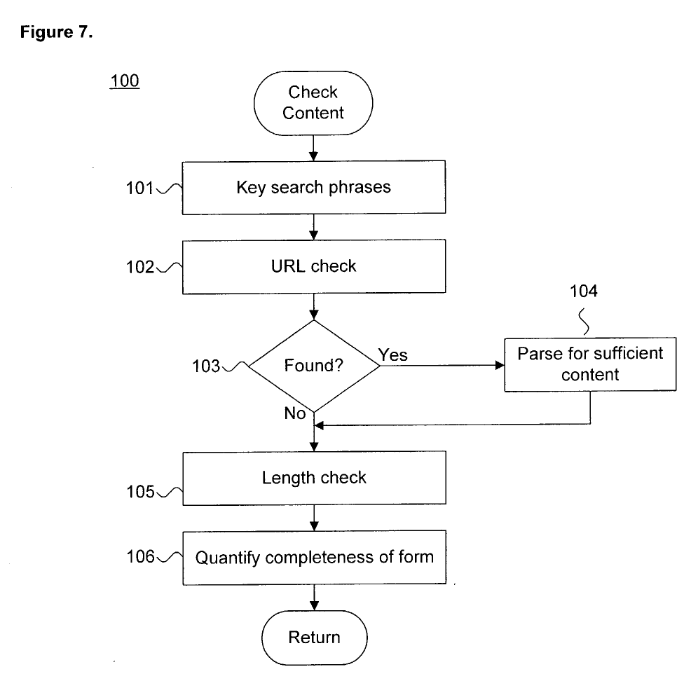

If the submission deadline has already occurred (block 81), the package is disapproved (block 82) and the routine returns. Otherwise, the submission package is reviewed. Each submission package consists of a form filled out via a Web browser 24 executing on a submitter client 13. Each field in the form is parsed into normalized content and stored (block 83). The content checked (block 84), as further described below with reference to FIG. 7. Substantially complete and correct submission packages are presented to approvers (block 85). In the described embodiment, a submission package must be 90% complete and correct for approver presentation. The submitted packages are displayed on the dashboard 26 (shown in FIG. 1), which includes a color-coded notification if the next deadline is close or the submission package has been modified recently (block 86). The routine then returns.

Application Submission Dashboard Screenshot

FIG. 6 is a screenshot showing, by way of example, the application submission dashboard 90 generated by the tuning server 11 of FIG. 1. The application submission dashboard 90 is part of a control console, which forms a logical framework for remotely managing a performance tuning initiative. The dashboard 90 is logically organized into three areas. The first area, search 91, provides Web-based searching capabilities. The second sections, menu 92, allows point-and-click selection of functional areas used for performance tuning initiative management. The third section, identification 93, provides user log-in and identification. Other types of controls or information display are feasible, as would be recognized by one skilled in the art.

Content Checking

FIG. 7 is a flow diagram showing a routine for checking content 100 for use in the routine of FIG. 5. The purpose of this routine is to check the contents of each of the eleven fields on a submission package form for completeness and correctness. First, key phrases are identified (block 101) to allow identification of the details of the submission package. If the field contains a Uniform Resource Locator (URL), the URL is checked (block 102) by executing a look-up of the referenced URL content, preferably on a search engine. If the referenced URL content is found (block 103), the content is parsed for sufficiency (block 94). Otherwise, processing continues by checking the length of the field content (block 104). In the described embodiment, each field entry must have a minimum of 40 characters or five words to help ensure a complete submission. Finally, the completeness of the form is quantified (block 105) as a percentage for use in color coding. A form that is less than 40% complete is coded red, 40-70% yellow, and greater than 70% green. The routine then returns.

Submission Approval

FIG. 8 is a flow diagram showing the routine for approving a submission 110 for use in the method of FIG. 5. The purpose of this routine is to automate the approval process on a field-by-field basis.

Thus, for each field in the form containing the submission package (block 111), the field is checked (block 112) by an approver on an approver client 14 (shown in FIG. 1). If approved (block 1113), the field in the form is validated (block 115). Otherwise, the submitter is notified (block 114). Submission approval continues with each successive field (block 116), after which the routine returns.

Tuning Dashboard Screenshot

FIG. 9 is a screenshot showing, by way of example, a tuning dashboard 120 generated by the tuning server 11 of FIG. 1. The tuning dashboard 120 is logically divided into two areas used for managing a performance tuning initiative. The first area, Controls 121, provides a point-and-click user interface for selecting and executing individual performance tuning management functions. The second area, Status Display 122, periodically displays each approved submission with an indication of completeness and any performance improvements gained or lost.

Bonus Approval

FIG. 10 is a flow diagram showing the routine for approving a bonus 130 for use in the method of FIG. 5. The purpose of this routine is to automate the process of awarding monetary incentives to those tuners who have successfully completed their performance tunings.

First, the various logs 30 stored in the database 12 (shown in FIG. 2) are closed (block 131), and the posting results are checked (block 132). If the ISV accepts the performance tuning results (block 133) the bonus is approved (block 135). Otherwise, the submitter is notified (block 134). The routine then returns.

Application Summary Screenshot

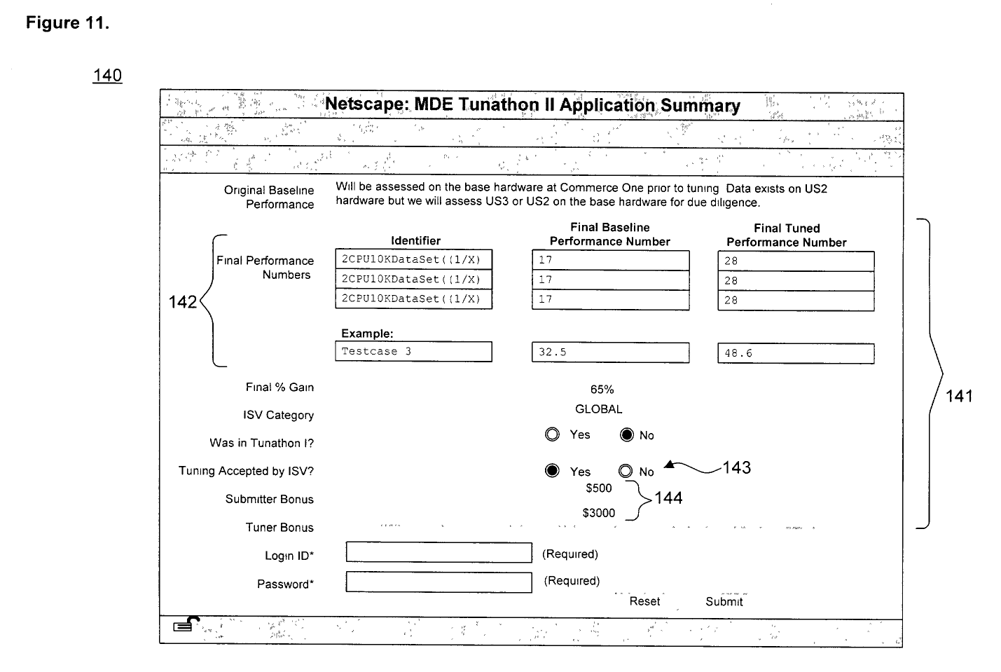

FIG. 11 is a screenshot showing, by way of example, an application summary 140 generated by the tuning server 11 of FIG. 1. The application summary 140 is logically divided into two areas. The first area, Summary 141, lists the overall results of a performance tuning initiative. The second area, Final Performance Numbers 142, specifically identifies the quantified performance gains (or losses) based on executed test cases. An indication 143 that the tuning has been accepted by an ISV and the amount of the performance tuning initiative award 144 are also provided.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for managing a computer system performance tuning initiative in a networked computing environment, comprising:
receiving a submission package comprising a plurality of individual fields identifying a software application candidate for performance tuning, each field describing a quantifiable aspect of the candidate software application;
parsing each field in the submission package into normalized content and evaluating the parsed content for completeness and correctness;
soliciting approval of each evaluated submission package for performance tuning by presenting a percentage reflecting overall completeness and correctness;
monitoring tuner sign-up and status and tracking performance tuning progress following approval of each evaluated submission package; and
apprising results from the performance tuning upon completion.

2. A method according to claim 1, further comprising:
quantifying the parsed content.

3. A method according to claim 1, further comprising:
setting a deadline tied to at least one of the group comprising package submission, tuner sign-up, and tuning completion; and
determining whether the deadline has occurred attendant to the at least one of package submission, tuner sign-up, and tuning completion.

4. A method according to claim 3, further comprising:
evaluating interim performance tuning results.

5. A method according to claim 1, further comprising:
generating a logical framework to remotely manage the performance tuning initiative.

6. A method according to claim 5, further comprising:
providing a graphical user interface with interactive user controls within the logical framework.

7. A method according to claim 1, further comprising:
periodically updating the tuner status.

8. A method according to claim 1, wherein the parsed content of at least one individual field comprises a Uniform Resource Locator (URL), further comprising:
executing a look-up of the referenced URL.

9. A method according to claim 1, further comprising:
generating a color-coded notification upon at least one event selected from the group comprising a close deadline and a recently-modified submission package.

10. A computer-readable storage medium holding instructions that when executed by a computer cause the computer to perform a method for managing a computer system performance tuning initiative in a networked computing environment, comprising code for:
receiving a submission package comprising a plurality of individual fields identifying a software application candidate for performance tuning, each field describing a quantifiable aspect of the candidate software application;
parsing each field in the submission package into normalized content and evaluating the parsed content for completeness and correctness;
soliciting approval of each evaluated submission package for performance tuning by presenting a percentage reflecting overall completeness and correctness;
monitoring tuner sign-up and status and tracking performance tuning progress following approval of each evaluated submission package; and
apprising results from the performance tuning upon completion.

11. A storage medium according to claim 10, further comprising code for:
quantifying the parsed content.

12. A storage medium according to claim 10, further comprising code for:
setting a deadline tied to at least one of the group comprising package submission, tuner sign-up, and tuning completion; and
determining whether the deadline has occurred attendant to the at least one of package submission, tuner sign-up, and tuning completion.

13. A storage medium according to claim 12, further comprising code for:
evaluating interim performance tuning results.

14. A storage medium according to claim 10, further comprising code for:
generating a logical framework to remotely manage the performance tuning initiative.

15. A storage medium according to claim 14, further comprising code for:
providing a graphical user interface with interactive user controls within the logical framework.

16. A storage medium according to claim 10, further comprising code for:
periodically updating the tuner status.

17. A storage medium according to claim 10, wherein the parsed content of at least one individual field comprises a Uniform Resource Locator (URL), further comprising code for:
executing a look-up of the referenced URL.

18. A storage medium according to claim 10, further comprising code for:
generating a color-coded notification upon at least one event selected from the group comprising a close deadline and a recently-modified submission package.

19. A system for managing a computer system performance tuning initiative in a networked computing environment, comprising:
a tuning server for a submission package comprising a plurality of individual fields identifying a software application candidate for performance tuning, each field describing a quantifiable aspect of the candidate software application, and parsing each field in the submission package into normalized content and evaluating the parsed content for completeness and correctness;
a submitter client soliciting approval of each evaluated submission package for performance tuning by presenting a percentage reflecting overall completeness and correctness, and monitoring tuner sign-up and status and tracking performance tuning progress following approval of each evaluated submission package; and
an approver client apprising results from the performance tuning upon completion.

20. A system according to claim 19, further comprising:
a parser quantifying the parsed content.

21. A system according to claim 19, further comprising:
a review module setting a deadline tied to at least one of the group comprising package submission, tuner sign-up, and tuning completion, and determining whether the deadline has occurred attendant to the at least one of package submission, tuner sign-up, and tuning completion.

22. A system according to claim 21, further comprising:
an evaluation module evaluating interim performance tuning results.

23. A system according to claim 19, further comprising:
a logical framework generated to remotely manage the performance tuning initiative.

24. A system according to claim 23, further comprising:
a graphical user interface with interactive user controls provided within the logical framework.

25. A system according to claim 19, further comprising:
a display periodically updating the tuner status.

26. A system according to claim 19, wherein the parsed content of at least one individual field comprises a Uniform Resource Locator (URL), further comprising:
a search engine executing a look-up of the referenced URL.

27. A system according to claim 19, further comprising:
a color-coded notification generated upon at least one event selected from the group comprising a close deadline and a recently-modified submission package.

28. An apparatus for managing a computer system performance tuning initiative in a networked computing environment, comprising:
means for receiving a submission package comprising a plurality of individual fields identifying a software application candidate for performance tuning, each field describing a quantifiable aspect of the candidate software application;
means for parsing each field in the submission package into normalized content and means for evaluating the parsed content for completeness and correctness;
means for soliciting approval of each evaluated submission package for performance tuning by presenting a percentage reflecting overall completeness and correctness;
means for monitoring tuner sign-up and status and tracking performance tuning progress following approval of each evaluated submission package; and
means for apprising results from the performance tuning upon completion.
